(19) United States
(12) Patent Application Publication
(10) Pub. No.: US 2026/0349966 A1
(43) Pub. Date: Nov. 5, 2026

(54) EFFICIENT IDENTIFICATION OF LOG EVENTS IN A DATABASE SYSTEM

(71) Applicant: CrowdStrike, Inc., Sunnyvale, CA (US)

(72) Inventor: Troels Leth Jensen, Aarhus N (DK)

(21) Appl. No.: 19/198,926

(22) Filed: May 5, 2025

(51) Int. Cl. G06F 16/18; G06F 16/28; G06F 21/00; G06F 21/55; G06F 21/57

(52) U.S. Cl. CPC G06F 16/1805; G06F 16/285; G06F 21/00; G06F 21/55; G06F 21/554; G06F 21/577

(57) ABSTRACT

A system and method including receiving a request to identify a collection of log events respectively associated with a collection of log files according to a selection criteria and one or more keywords. The method includes searching the database system to identify a set of log events based on the one or more keywords. The method includes generating a plurality of groups for the set of log events by assigning a first log event of the set of log events to a first group based on additional log events within the first group and assigning a second log event of the set of log events to the first group based on the additional log events in the first group. The method includes generating a report indicating that a subset of the set of log events correspond to the selection criteria.

### TECHNICAL FIELD

The present disclosure relates to data processing, and more particularly, to systems and methods of an advanced database searching system that intelligently groups data in the database to minimize the amount of computing resources demanded to search the database.

### BACKGROUND

Database systems and data warehouses are both important tools for managing and analyzing data. A database system is designed for online transactional processing (OLTP), which involves managing day-to-day operations and transactions. It stores current data and supports simple, fast queries to retrieve specific records. In contrast, a data warehouse is optimized for online analytical processing (OLAP), which involves analyzing large volumes of historical data to support decision-making. Data warehouses aggregate data from multiple sources and use complex queries to identify trends and patterns. While databases focus on quick, efficient transaction processing, data warehouses prioritize query performance for in-depth analysis, often employing techniques like indexing, partitioning, and caching to handle large datasets efficiently.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram depicting an example environment for intelligently grouping data in the database to minimize the amount of computing resources demand to search the database, according to some embodiments;

FIG. 2A is a block diagram depicting an example of advanced database searching (ADS) system of the environment in FIG. 1, according to some embodiments;

FIG. 2B is a block diagram depicting an example of a client device in FIG. 1, according to some embodiments;

FIG. 2C is a block diagram depicting an example environment for using the ADS system in FIG. 1, according to some embodiments;

FIG. 3 is a flow diagram depicting a method of intelligently grouping data in the database to minimize the amount of computing resources demanded to search the database, according to some embodiments; and

FIG. 4 is a block diagram of an example computing device that may perform one or more of the operations described herein, in accordance with some embodiments.

### DETAILED DESCRIPTION

Searching a database can be challenging due to the sheer volume of data, making it hard to find specific information quickly. For example, a system might attempt to find a lowest k elements out of a huge amount of possible values; thereby making it impossible to keep all the data in memory at the same time. The conventional system can only find the lowest k values in by maintaining and consuming a massive amount of memory, which is impractical. Thus, there is a long-felt but unsolved need for a solution for efficiently searching large databases for specific dataset without consuming excess computing resources, such as processing and memory.

Aspects of the present disclosure address the above-noted and other deficiencies by providing an advanced database searching (ADS) system that intelligently groups data stored in a database to minimize the amount of computing resources that are demanded to search the database. The ADS system maintains a list of groups which are sorted according to a sorting algorithm. The ADS system ensures that the elements in the smallest group are smaller than all other elements in any other group, allowing the ADS system to use a binary search to quickly find which group to add an element to. After processing the elements, the ADS system can check whether to drop the largest group of elements from memory to further improve its search performance and resource allocation when processing queries.

In an illustrative embodiment, an advanced database searching (ADS) system that intelligently groups data in the database to minimize the amount of computing resources demanded to search the database. The ADS system receives a request to identify, in a database system, a collection of log events respectively associated with a collection of log files according to a selection criteria and an event type. The ADS system searches the database system to identify a set of log events based on the event type. The ADS system generates a plurality of groups for the set of log events by assigning a first log event of the set of log events to a first group based on additional log events within the first group and assigning a second log event of the set of log events to the first group based on the additional log events in the first group. The ADS system generates, from the plurality of groups, a report indicating that a subset of the set of log events correspond to the selection criteria.

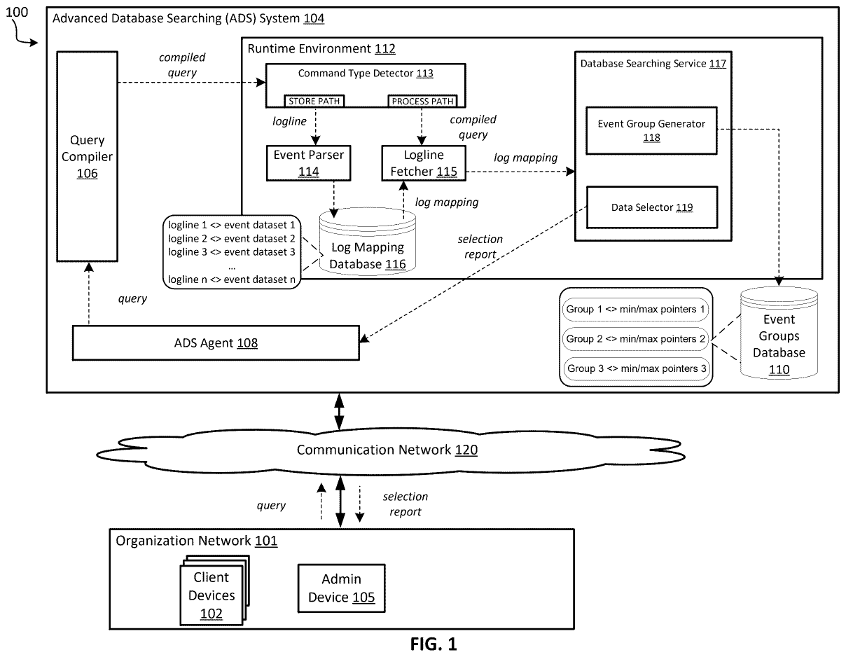

FIG. 1 is a block diagram depicting an example environment for intelligently grouping data in the database to minimize the amount of computing resources demand to search the database, according to some embodiments. Environment 100 includes an advanced database searching (ADS) system 104 and an organization network 101 that are each communicably coupled together via a communication network 120. An organization network may include, for example, a corporation's computing network, a government agency's computing network, an educational institution's computing network, a private computing network, or similar computing networks.

The organization network 101 includes a plurality of client devices 102. The organization network 101 also includes an admin device 105, which has permission to send requests (shown in FIG. 1 as query) to the ADS system 104, where the request is for the ADS system 104 to identify a collection of log events that are respectively associated with a collection of log files according to a selection criteria and an event type.

The ADS system 104 includes a query compiler 106, an ADS agent 108, and a runtime environment 112. The runtime environment 112 includes a command type detector 113, an event parser 114, a logline fetcher 115, and a database searching service 117. The database searching service 117 includes an event group generator 118 and a data selector 119.

The ADS system 104 includes a plurality of databases that are configured to store different datasets. Specifically, the ADS system 104 includes a log mapping database 116 that is configured to store a mapping between a plurality of loglines and a plurality of event datasets (e.g., process identifier, session identifier), where each logline is respectively associated with an event dataset that includes one or more items of event data. For example, as shown in FIG. 1, logline 1 is mapped to event dataset 1, logline 2 is mapped to event dataset 2, logline 3 is mapped to event dataset 3, and so on. A log line is an alphanumeric string of data that is generated by and sent from a computing device, such as client device 102 or any component of the ADS system 104. A log line may include a timestamp (indicating when the log line was generated by the computing device) and a string of text describing one or more operations (e.g., register read/write, file system read/write, launching an application) that were performed by the computing device.

The ADP system 104 also includes an event groups database 110 that is configured to store a mapping between a plurality of group numbers and a plurality of min/max pointers. For example, group 1 may be mapped to a min pointer of 1 and a max pointer of 3; group 2 may be mapped to a min pointer of 4 and a max pointer of 6; and group 3 may be mapped to a min pointer of 7 and a max pointer of 9. By using pointers to keep track of the min and max event values per group, the ADP system 104 is able to efficiently determine which group of the groups in the event groups database 110 the ADP system 104 should assign an event to without having to search through all data in the log mapping database 116 to make this decision. Similarly, this also allows the ADP system 104 to efficiently search for datasets in the log mapping database 116 that match a particular selection criteria without having to search through all data in the log mapping database 116. Both of these features result in significant improvements in search performance and resource allocation when processing queries.

In some embodiments, the ADP system 104 may store the mappings between the plurality of group numbers and the plurality of min/max pointers in a local memory of the ADP system 104 to reduce the time to retrieve the mappings.

As used herein, a dataset may be a collection of data that is organized in a structured format (e.g., in rows and columns) or in an unstructured format that does not have a predefined model or organization.

In some embodiments, each of the components (e.g., a query compiler 106, an ADS agent 108, and a runtime environment 112) of the ADS system 104 may be housed into a single computing device (e.g., a server, a laptop, a desktop, a host device, etc.). However, in other embodiments, some or all of the components of the ADS system 104 may be included in separate computing device and/or database that are geographically/physically separate from one another, but communicatively coupled via the communication network 120. Similarly, each of the databases (e.g., log mapping database 116, event groups database 110) may correspond to its own separate database that is geographically/physically separate from the servers and other databases, but communicatively coupled via the communication network 120.

The communication network 120 may be a public network (e.g., the internet), a private network (e.g., a local area network (LAN) or wide area network (WAN), or a combination thereof. In one embodiment, communication network 120 may include a wired or a wireless infrastructure, which may be provided by one or more wireless communications systems, such as Wi-Fi® connectivity to the communication network 120 and/or a wireless carrier system that can be implemented using various data processing equipment, communication towers (e.g., cell towers), etc. The communication network 120 may carry communications (e.g., data, message, packets, frames, etc.) between any other the computing device.

The ADS system 104 and client device 102 may each be any suitable type of computing device or machine that has a processing device, for example, a server computer (e.g., an application server, a catalog server, a communications server, a computing server, a database server, a file server, a game server, a mail server, a media server, a proxy server, a virtual server, a web server), a desktop computer, a laptop computer, a tablet computer, a mobile device, a smartphone, a set-top box, a graphics processing unit (GPU), etc. In some examples, a computing device may include a single machine or may include multiple interconnected machines (e.g., multiple servers configured in a cluster).

A computing device may be one or more virtual environments. In one embodiment, a virtual environment may be a virtual machine (VM) that may execute on a hypervisor which executes on top of an operating system (OS) for a computing device. The hypervisor may manage system sources (including access to hardware devices, such as processing devices, memories, storage devices). The hypervisor may also emulate the hardware (or other physical resources) which may be used by the VMs to execute software/applications. In another embodiment, a virtual environment may be a container that may execute on a container engine which executes on top of the OS for a computing device. For example, a container engine may allow different containers to share the OS of a computing device (e.g., the OS kernel, binaries, libraries, etc.). A computing device may use the same type or different types of virtual environments. For example, all of the computing devices may be VMs. In another example, all of the computing devices may be containers. In a further example, some of the computing devices may be VMs, other computing device may be containers, and other computing devices may be computing devices (or groups of computing devices).

Still referring to FIG. 1, the ADS agent 108 receives a request (shown in FIG. 1 as query) from a client device 102, where the request is to identify, in a database system (e.g., log mapping database 116), a collection of log events that are respectively associated with a collection of log files according to a selection criteria (e.g., smallest numbers, largest numbers) and an event type (e.g., process ID, session ID). The query may also indicate that the request is for a total count (e.g., k value) of the log events that meet the selection criteria and event type. In some embodiments, the request may be to store a logline in the log mapping database 116, where the request includes the logline.

The query compiler 106 sends the query to the query compiler 106. The query compiler 106 analyzes the query to generate a compiled query, which is a representation that indicates a hierarchical structure of a plurality of commands (e.g., a memory read command, a memory write command, a rename command, a count command) that are included in the query. The query compiler 106 sends the query to the command type detector 113.

If the command type detector 113 determines that the query is a request to store a logline in the log mapping database 116, then the command type detector 113 forwards the logline to event parser 114. The event parser 114 parses the logline to extract one or more event datasets from the logline and then stores a log mapping in the log mapping database 116, where the logline mapping associates the logline with the extracted event datasets.

Otherwise, if the command type detector 113 determines that the query is a request to search the log mapping database 116 based on a search criteria, then the command type detector 113 forwards the compiled query to the logline fetcher 115. In an iterative fashion, the logline fetcher 115 retrieves each log mapping (each including a log line and one or more event data) from the log mapping database 116 and forward the log mappings to the database searching service 117 to be sequentially processed.

The database searching service 117 processes each log mapping by generating a plurality of groups for log events and storing the plurality of groups in the event groups database 110 and/or a local memory of the ADS system 104. The data selector 119 selects a set of log events in the log mapping database or the local memory according to the selection criteria, event type, and total count (e.g., k value) indicated in the query. The data selector 119 generates, from the plurality of groups, a report indicating the selection.

Although FIG. 1 shows only a select number of computing devices (e.g., ADS system 104, client devices 102); the environment 100 may include any number of computing devices that are interconnected in any arrangement to facilitate the exchange of data between the computing devices.

### Additional Examples

The following examples show that the ADS system 104 creates groups and keeps track of the minimum element and the maximum element per group, according to the following format: [group number]=[min element, max element]

As an example, the ADS system 104 processes a logline that includes an event type (e.g., process ID) equal to event 7 (or simply 3). The ADS system 104 determines that no groups exist yet, so the ADS system 104 creates group_1 and adds 7 to group_1 as the sole member. The ADS system 104 updates pointers to indicate the following: group_1=[7,7].

As another example, the ADS system 104 processes a logline that includes an event type equal to event 3. The ADS system 104 performs a binary search on group_1 and determines that 3 is smaller than all elements of group_1. Specifically, event 3 does not fall between the min and max (e.g., [7,7]) of group_1. Therefore, the ADS system 104 proceeds to prioritize the following actions: (a) If the smallest (in terms of group size) neighboring group has fewer events than ceil (K/(max number of groups−1)) events, then the ADS system 104 adds the event to the smallest neighboring group. (b) Otherwise, if there exist less groups than the upper limit on groups, then the ADS system 104 creates a new group with the event as sole member. (c) Otherwise, if the smallest (in terms of group size) neighboring group has fewer events, then the ADS system 104 adds the event to the smallest neighboring group. (d) If a-c is false, then the ADS system 104 performs a rebalance of the groups by moving one or more log events from a first group to another group. In some embodiments, the smallest neighboring group is the first. In some embodiments, it does have fewer than 2 events, so the ADS system 104 chooses action (a). After processing event 3, the ADS system 104 updates pointers to indicate the following: group_1=[3,7].

As another example, the ADS system 104 processes another logline that includes an event type equal to event 11. The ADS system 104 performs a binary search on group_1 and determines that 11 falls outside of group_1 which is the only existing group. Since the smallest neighboring group has 2 elements, the ADS system 104 selects and performs action (b) as discussed above. After processing event 11, the ADS system 104 updates pointers to indicate the following: group_1=[3,7]; group_2=[11,11].

As another example, the ADS system 104 processes another logline that includes an event type equal to event 8. The ADS system 104 performs a binary search on the existing groups (e.g., group_1 and group_2) and determines that 8 falls outside of the min and max of the existing groups (e.g., [3,7]; [11,11]). After processing event 8, the ADS system 104 updates pointers to indicate the following: group_1=[3,7]; group_2=[8,11].

As another example, the ADS system 104 processes another logline that includes an event type equal to event 10. The ADS system 104 performs a binary search on the existing groups (e.g., group_1 and group_2) and determines that 10 falls in group_2. When the ADS system 104 processes an event that falls within an existing group, then the ADS system 104 proceeds to prioritize the following actions: (x) if there is room in the group, then the ADS system 104 adds event 10 to that group; (y) Otherwise, if there is a free group, then the ADS system 104 partitions the free group into a first new group and a second new group using the new event as pivot, and then adds the new event to the smallest of the new groups; (z) otherwise, the ADS system 104 rebalances one or more of the existing groups.

As another example, the ADS system 104 processes another logline that includes an event type equal to event 9. The ADS system 104 performs a binary search on the existing groups (e.g., group_1 and group_2), which include [3, 7, 8, 11] because previously processing Event 10 did not change any min or max of any of the groups. Upon performing the binary search, the ADS system 104 determines that 9 falls inside the min and max of group_2 (e.g., [8,11]. This time, however, the ADS system 104 determines that there is no room for additional events, but that there is room for one more group. Therefore, the ADS system 104 performs action (x) described above. That is, the ADS system 104 partitions group_2 using 9 as the pivot value to split group_2 into [8] and [10,11]. The ADS system 104 then adds 9 to [8]. After processing event 9, the ADS system 104 updates pointers to indicate the following: group_1=[3,7]; group_2=[9,8]; group_3=[11,10]. However, the ADS system 104 may then determine that group_1 and group_2 have ‘k’ or more elements, where ‘k’ was previously defined in the query that was sent from the client device 102. In response, the ADS system 104 may decide to drop (e.g., delete, erase) group_3 and update the pointers to indicate the following: group_1=[3,7]; group_2=[9,8].

As another example, the ADS system 104 processes another logline that includes an event type equal to event 4. The ADS system 104 performs a binary search on the existing groups (e.g., group_1 and group_2), which include [3, 7, 8, 9] to determine that 4 falls inside the min and max of group_1 (e.g., [3,4]. In response, the ADS system 104 adds 4 to the group_1 because there is room in group_1. After processing event 4, the ADS system 104 maintains the same pointer values indicating the following: group_1=[3,7]; group_2=[9,8].

As another example, the ADS system 104 processes another logline that includes an event type equal to event 1. The ADS system 104 performs a binary search on the existing groups (e.g., group_1 and group_2), which include [3, 7, 8, 9] to determine that 1 falls below the min of group_1 and min of group_2, and that group_1 is the only neighbor to event 1. The ADS system 104 also determines that group_1 is too full for it to perform action (a) above; therefore, the ADS system 104 instead decides to perform action (b), described above. After processing event 1, the ADS system 104 updates the pointers to indicate the following: group_1=[1,1]; group_2=[3,7]; [8,9]. Furthermore, the ADS system 104 may then determine that the smallest two groups have k or more elements, and in response, decide to drop the largest group and update the pointers to indicate the following: group_1=[1,1]; group_2=[3, 7, 4].

After processing each of the above examples, the ADS system 104 may determine that there are no more events to process and proceed to obtain the final results from the groups: [1,3,7,4].

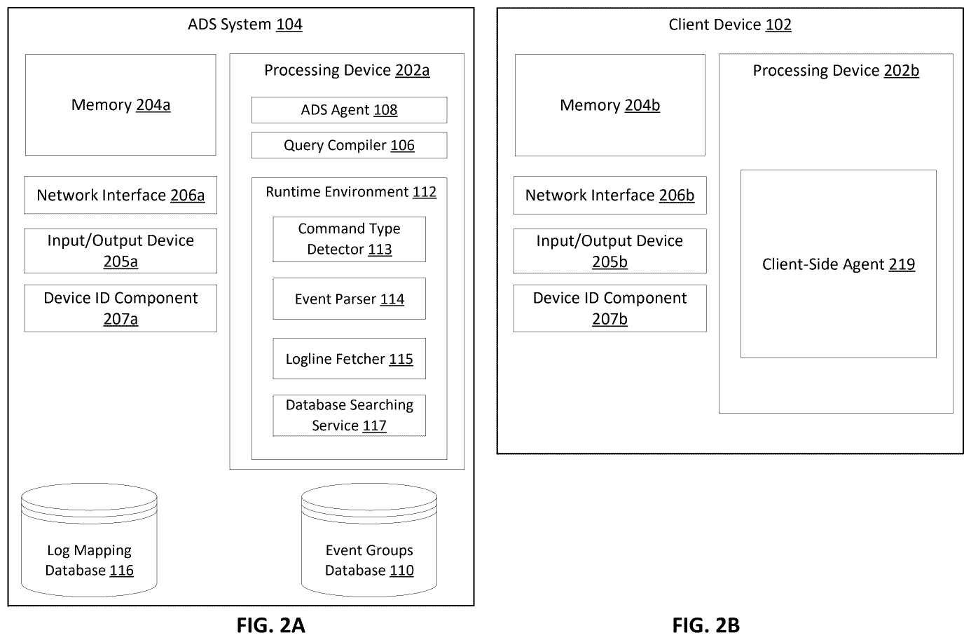

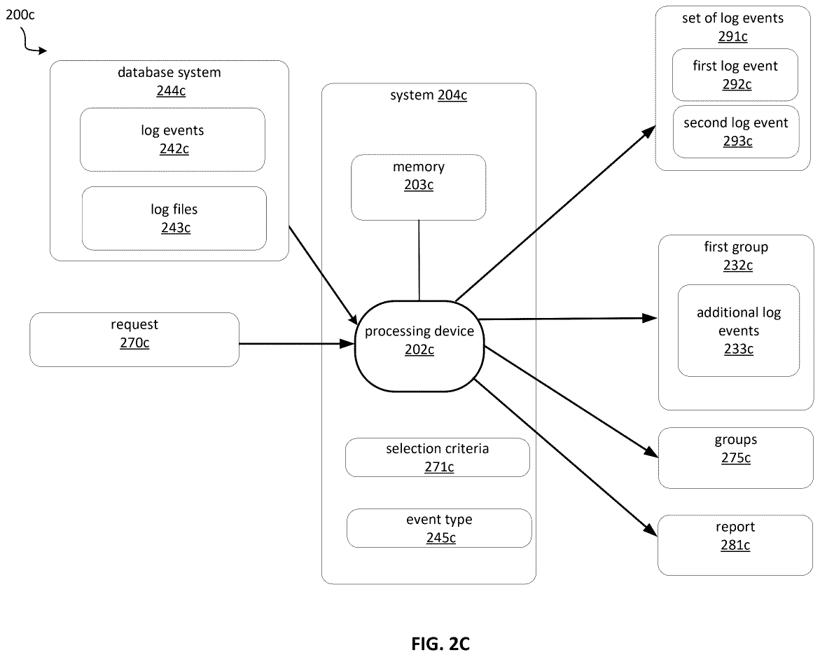

FIG. 2A is a block diagram depicting an example of advanced database searching (ADS) system of the environment in FIG. 1, according to some embodiments. While various devices, interfaces, and logic with particular functionality are shown, it should be understood that the ADS system 104 includes any number of devices and/or components, interfaces, and logic for facilitating the functions described herein. For example, the activities of multiple devices may be combined as a single device and implemented on a same processing device (e.g., processing device 202a), as additional devices and/or components with additional functionality are included.

The ADS system 104 includes a processing device 202a (e.g., general purpose processor, a PLD, etc.), which may be composed of one or more processors, and a memory 204a (e.g., synchronous dynamic random-access memory (DRAM), read-only memory (ROM)), which may communicate with each other via a bus (not shown).

The processing device 202a may be provided by one or more general-purpose processing devices such as a microprocessor, central processing unit, or the like. In some embodiments, processing device 202a may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the processing device 202a may include one or more special-purpose processing devices such as an application specific integrated circuit (ASIC), a field programmable gate array (FPGA), a digital signal processor (DSP), network processor, or the like. The processing device 202a may be configured to execute the operations described herein, in accordance with one or more aspects of the present disclosure, for performing the operations and steps discussed herein.

The memory 204a (e.g., Random Access Memory (RAM), Read-Only Memory (ROM), Non-volatile RAM (NVRAM), Flash Memory, hard disk storage, optical media, etc.) of processing device 202a stores data and/or computer instructions/code for facilitating at least some of the various processes described herein. The memory 204a includes tangible, non-transient volatile memory, or non-volatile memory. The memory 204a stores programming logic (e.g., instructions/code) that, when executed by the processing device 202a, controls the operations of the ADS system 104. In some embodiments, the processing device 202a and the memory 204a form various processing devices and/or circuits described with respect to the ADS system 104. The instructions include code from any suitable computer programming language such as, but not limited to, C, C++, C #, Java, JavaScript, VBScript, Perl, HTML, XML, Python, TCL, and Basic.

The processing device 202a executes and/or includes ADS agent 108 and query compiler 106. The processing device 202a also executes and/or includes runtime environment 112, which includes command type detector 113, event parser 114, logline fetcher 115, and database searching service 117.

The processing device 202a may be configured to receive a request to identify, in a database system, a collection of log events respectively associated with a collection of log files according to a selection criteria (e.g., smallest or largest) and an event type (e.g., process ID, session). The processing device 202a may be configured to search the database system (e.g., log mapping database) to identify a set of log events based on the event type. The processing device 202a may be configured to generate a plurality of groups for the set of log events by assigning a first log event of the set of log events to a first group based on additional log events within the first group and assigning a second log event of the set of log events to the first group based on the additional log events in the first group. The processing device 202a may be configured to generate, from the plurality of groups, a report indicating that a subset of the set of log events correspond to the selection criteria.

In some embodiments, the selection criteria includes a first rule to select, from the plurality of groups, smallest log events corresponding to the event type, and a second rule to select a total count (e.g., k value) of the smallest log events from the plurality of groups.

The processing device 202a may be configured to generate the plurality of groups by determining a first minimum log event and a first maximum log event from a first set of assigned log events in the first group; determining a second minimum log event and a second maximum log event from a second set of assigned log events in a second group; and updating a plurality of pointers to indicate at least one of the first minimum log event, the first maximum log event, the second minimum log event, or the second maximum log event.

The processing device 202a may be configured to perform, based on the plurality of pointers, a binary search to determine that a third log event of the set of log events is less than the first minimum log event in the first group and the second minimum log event in the second group. The processing device 202a may be configured to identify the first group as a nearest neighboring group for the third log event responsive to performing the binary search. The processing device 202a may be configured to add the third log event to the first group responsive to identifying the first group as the nearest neighboring group for the third log event.

The processing device 202a may be configured to generate the plurality of groups by performing, based on the plurality of pointers, a binary search to determine that a third log event of the set of log events is greater than the first maximum log event in the first group and less than the second minimum log event in the second group; identifying the first group and the second group as nearest neighboring groups for the third log event; and determining that the second group is smaller than the first group based on a first total count of log events in the first group and a second total count of log events in the second group. The processing device 202a may be configured to remediate (e.g., stop processing of, quarantine, isolate, sandbox, remove) a cybersecurity threat based on the third log event.

The processing device 202a may be configured to generate the plurality of groups by determining whether the second total count of log events in the second group exceeds a hysteresis value; and either adding the third log event to the second group responsive to determining that the second total count of log events in the second group does not exceed the hysteresis value, or adding, to the plurality of groups, an additional group including the third log event responsive to determining that the second total count of log events in the second group exceeds the hysteresis value.

The processing device 202a may be configured to generate the plurality of groups by determining an inability to add the third log event to one or more groups of the plurality of groups; and rebalancing the plurality of groups based on the third log event.

The processing device 202a may be configured to generate the plurality of groups by performing, based on the plurality of pointers, a binary search to determine that a third log event of the set of log events falls within the first group based on the first minimum log event in the first group and the first minimum log event in the first group; determining whether there is space to add the third log event to the first group; and either adding the third log event to the first group responsive to determining that there is space to add the third log event to the first group, or abstaining, to the plurality of groups, from adding the third log event to the first group responsive to determining that there is no space to add the third log event to the first group.

The processing device 202a may be configured to abstain, to the plurality of groups, from adding the third log event to the first group by determining whether there is space to add an additional group to the plurality of groups; and either partitioning, based on the third log event, the additional group into a third group and a fourth group responsive to determining that there is space to add the additional group to the plurality of groups; or rebalancing the plurality of groups based on the third log event responsive to determining that there is no space to add the additional group to the plurality of groups.

The processing device 202a may be configured to partition, based on the third log event, the additional group into the third group and the second group further by determining that the third group is smaller than the fourth group based on a third total count of log events in the third group and a fourth total count of log events in the fourth group; and adding the third log event to the third group responsive to determining that the third group is smaller than the fourth group.

The ADS system 104 includes a network interface 206a configured to establish a communication session with a computing device for sending and receiving data over the communication network 120 to the computing device. Accordingly, the network interface 206a includes a cellular transceiver (supporting cellular standards), a local wireless network transceiver (supporting 802.11X, ZigBee, Bluetooth, Wi-Fi, or the like), a wired network interface, a combination thereof (e.g., both a cellular transceiver and a Bluetooth transceiver), and/or the like. In some embodiments, the ADS system 104 includes a plurality of network interfaces 206a of different types, allowing for connections to a variety of networks, such as local area networks (public or private) or wide area networks including the Internet, via different sub-networks.

The ADS system 104 includes an input/output device 205a configured to receive user input from and provide information to a user. In this regard, the input/output device 205a is structured to exchange data, communications, instructions, etc. with an input/output component of the ADS system 104. Accordingly, input/output device 205a may be any electronic device that conveys data to a user by generating sensory information (e.g., a visualization on a display, one or more sounds, tactile feedback, etc.) and/or converts received sensory information from a user into electronic signals (e.g., a keyboard, a mouse, a pointing device, a touch screen display, a microphone, etc.). The one or more user interfaces may be internal to the housing of the ADS system 104, such as a built-in display, touch screen, microphone, etc., or external to the housing of ADS system 104, such as a monitor connected to ADS system 104, a speaker connected to ADS system 104, etc., according to various embodiments. In some embodiments, the ADS system 104 includes communication circuitry for facilitating the exchange of data, values, messages, and the like between the input/output device 205a and the components of the ADS system 104. In some embodiments, the input/output device 205a includes machine-readable media for facilitating the exchange of information between the input/output device 205a and the components of the ADS system 104. In still another embodiment, the input/output device 205a includes any combination of hardware components (e.g., a touchscreen), communication circuitry, and machine-readable media.

The ADS system 104 includes a device identification component 207a (shown in FIG. 2A as device ID component 207a) configured to generate and/or manage a device identifier associated with the ADS system 104. The device identifier may include any type and form of identification used to distinguish the ADS system 104 from other computing devices. In some embodiments, to preserve privacy, the device identifier may be cryptographically generated, encrypted, or otherwise obfuscated by any device and/or component of ADS system 104. In some embodiments, the ADS system 104 may include the device identifier in any communication (e.g., selection report, etc.) that the ADS system 104 sends to a computing device.

The ADS system 104 includes a bus (not shown), such as an address/data bus or other communication mechanism for communicating information, which interconnects the devices and/or components of ADS system 104, such as processing device 202a, network interface 206a, input/output device 205a, and device ID component 207a.

In some embodiments, some or all of the devices and/or components of ADS system 104 may be implemented with the processing device 202a. For example, the ADS system 104 may be implemented as a software application stored within the memory 204a and executed by the processing device 202a. Accordingly, such embodiment can be implemented with minimal or no additional hardware costs. In some embodiments, any of these above-recited devices and/or components rely on dedicated hardware specifically configured for performing operations of the devices and/or components.

FIG. 2B is a block diagram depicting an example of a client device in FIG. 1, according to some embodiments. While various devices, interfaces, and logic with particular functionality are shown, it should be understood that the client device 102 includes any number of devices and/or components, interfaces, and logic for facilitating the functions described herein. For example, the activities of multiple devices may be combined as a single device and implemented on a same processing device (e.g., processing device 202b), as additional devices and/or components with additional functionality are included.

The client device 102 includes a processing device 202b (e.g., general purpose processor, a PLD, etc.), which may be composed of one or more processors, and a memory 204b (e.g., synchronous dynamic random-access memory (DRAM), read-only memory (ROM)), which may communicate with each other via a bus (not shown). The processing device 202b includes identical or nearly identical functionality as processing device 202a in FIG. 2A, but with respect to devices and/or components of the client device 102 instead of devices and/or components of the ADS system 104.

The memory 204b of processing device 202b stores data and/or computer instructions/code for facilitating at least some of the various processes described herein. The memory 204b includes identical or nearly identical functionality as memory 204a in FIG. 2A, but with respect to devices and/or components of the client device 102 instead of devices and/or components of the ADS system 104.

The processing device 202b may be configured to execute a client-side agent 219 that sends a request to the ADS system 104, where the request is to identify, in a database system (e.g., log mapping database 116), a collection of log events that are respectively associated with a collection of log files according to a selection criteria and/or an event type. The client-side agent 219 may be configured to receive a report from the ADS system 104, where the report indicates that a subset of the set of log events correspond to the selection criteria. The client-side agent 219 may be configured to determine an additional selection criteria and/or an additional event type based on the report. The client-side agent 219 may be configured to send the subsequent request to the ADS system 104, where the request is to identify, in the database system, an additional collection of log events that are respectively associated with an additional collection of log files according to the additional selection criteria and/or an additional event type. The client-side agent 219 may be configured to receive an additional report from the ADS system 104, where the additional report indicates that an additional subset of the set of log events correspond to the additional selection criteria. The client-side agent 219 may be configured to iteratively repeat the above-recited process to further refine the search results.

The client device 102 includes a network interface 206b configured to establish a communication session with a computing device for sending and receiving data over a network to the computing device. Accordingly, the network interface 206b includes identical or nearly identical functionality as network interface 206a in FIG. 2A, but with respect to devices and/or components of the client device 102 instead of devices and/or components of the ADS system 104.

The client device 102 includes an input/output device 205b configured to receive user input from and provide information to a user. In this regard, the input/output device 205b is structured to exchange data, communications, instructions, etc. with an input/output component of the client device 102. The input/output device 205b includes identical or nearly identical functionality as input/output device 205a in FIG. 2A, but with respect to devices and/or components of the client device 102 instead of devices and/or components of the ADS system 104.

The client device 102 includes a device identification component 207b (shown in FIG. 2B as device ID component 207b) configured to generate and/or manage a device identifier associated with the client device 102. The device ID component 207b includes identical or nearly identical functionality as device ID component 207a in FIG. 2A, but with respect to devices and/or components of the client device 102 instead of devices and/or components of the ADS system 104.

The client device 102 includes a bus (not shown), such as an address/data bus or other communication mechanism for communicating information, which interconnects the devices and/or components of the client device 102, such as processing device 202b, network interface 206b, input/output device 205b, and device ID component 207b.

In some embodiments, some or all of the devices and/or components of client device 102 may be implemented with the processing device 202b. For example, the client device 102 may be implemented as a software application stored within the memory 204b and executed by the processing device 202b. Accordingly, such embodiment can be implemented with minimal or no additional hardware costs. In some embodiments, any of these above-recited devices and/or components rely on dedicated hardware specifically configured for performing operations of the devices and/or components.

FIG. 2C is a block diagram depicting an example environment for using the ADS system in FIG. 1, according to some embodiments. The system 204c (e.g., ADS system 104 in FIG. 1) includes a memory 203c and a processing device 202c that is operatively coupled to the memory 203c. The processing device 202c is configured to receive a request 270c to identify, in a database system 244c, a collection of log events 242c respectively associated with a collection of log files 243c according to a selection criteria 271c and an event type 245c. The processing device 202c is configured to search the database system 244c to identify a set of log events 291c based on the event type 245c. The processing device 202c is configured to generate a plurality of groups 275c for the set of log events 291c by assigning a first log event 292c of the set of log events 291c to a first group 232c based on additional log events 233c within the first group 232c and assigning a second log event 293c of the set of log events 291c to the first group 232c based on the additional log events 233c in the first group 232c. The processing device 202c is configured to generate, from the plurality of groups 275c, a report 281c indicating that a subset of the set of log events correspond to the selection criteria 271c.

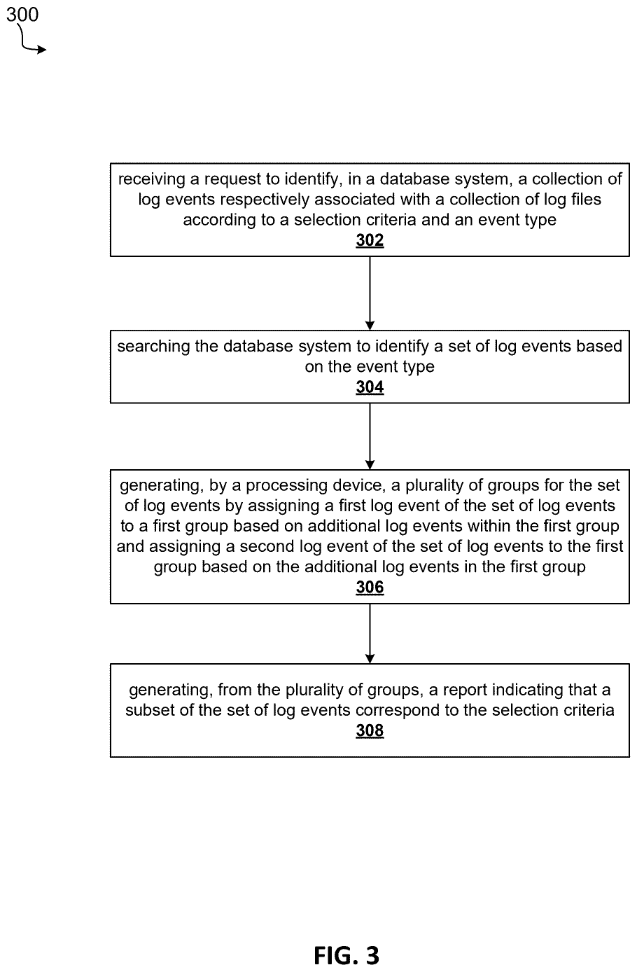

FIG. 3 is a flow diagram depicting a method of intelligently grouping data in the database to minimize the amount of computing resources demanded to search the database, according to some embodiments. Method 300 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, one or more blocks of method 300 may be performed by one or more advanced database searching system, such as ADS system 104 in FIG. 1.

With reference to FIG. 3, method 300 illustrates example functions used by various embodiments. Although specific function blocks (“blocks”) are disclosed in method 300, such blocks are examples. That is, embodiments are well suited to performing various other blocks or variations of the blocks recited in method 300. It is appreciated that the blocks in method 300 may be performed in an order different than presented, and that not all of the blocks in method 300 may be performed.

As shown in FIG. 3, the method 300 includes the block 302 of receiving a request to identify, in a database system, a collection of log events respectively associated with a collection of log files according to a selection criteria and an event type. The method 300 includes the block 304 of searching, by a runtime environment, the database system to identify a set of log events based on the event type. The method 300 includes the block 306 of generating a plurality of groups for the set of log events by assigning a first log event of the set of log events to a first group based on additional log events within the first group and assigning a second log event of the set of log events to the first group based on the additional log events in the first group. The method 300 includes the block 308 of generating, from the plurality of groups, a report indicating that a subset of the set of log events correspond to the selection criteria.

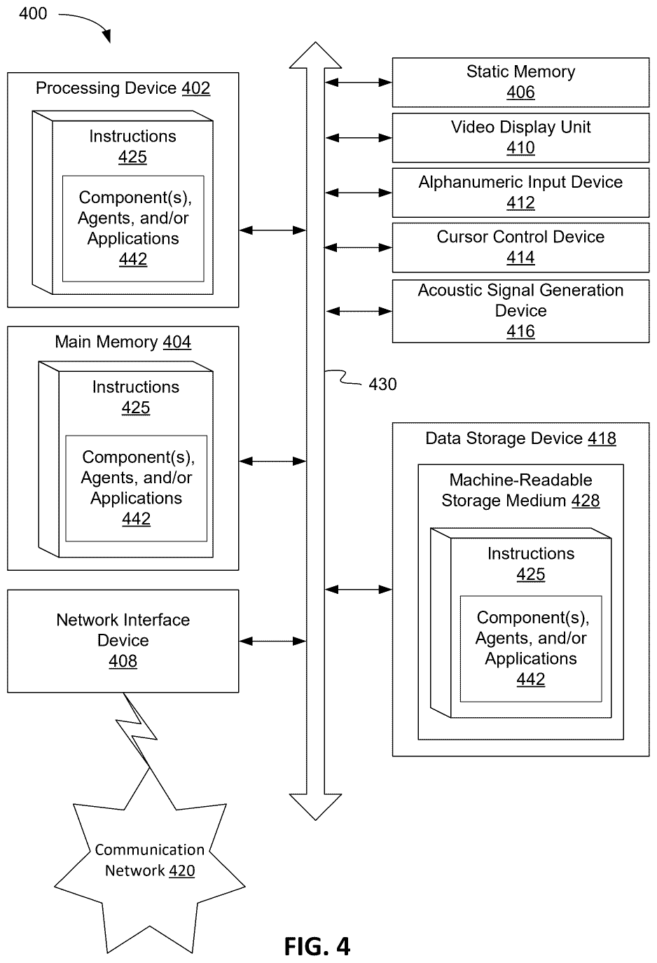

FIG. 4 is a block diagram of an example computing device that may perform one or more of the operations described herein, in accordance with some embodiments. Computing device 400 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 400 may include a processing device (e.g., a general-purpose processor, a PLD, etc.) 402, a main memory 404 (e.g., synchronous dynamic random-access memory (DRAM), read-only memory (ROM)), a static memory 406 (e.g., flash memory and a data storage device 418), which may communicate with each other via a bus 430.

Processing device 402 may be provided by one or more general-purpose processing devices such as a microprocessor, central processing unit, or the like. In an illustrative example, processing device 402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 402 may also include one or more special-purpose processing devices such as an application specific integrated circuit (ASIC), a field programmable gate array (FPGA), a digital signal processor (DSP), network processor, or the like. The processing device 402 may be configured to execute the operations described herein, in accordance with one or more aspects of the present disclosure, for performing the operations and steps discussed herein.

Computing device 400 may further include a network interface device 408 which may communicate with a communication network 420. The computing device 400 also may include a video display unit 410 (e.g., a liquid crystal display (LCD) or a cathode ray tube (CRT)), an alphanumeric input device 412 (e.g., a keyboard), a cursor control device 414 (e.g., a mouse) and an acoustic signal generation device 416 (e.g., a speaker). In one embodiment, video display unit 410, alphanumeric input device 412, and cursor control device 414 may be combined into a single component or device (e.g., an LCD touch screen).

Data storage device 418 may include a computer-readable storage medium 428 on which may be stored one or more sets of instructions 425 that may include instructions for one or more components/programs/applications 442 (e.g., query compiler 106, ADS agent 108, runtime environment 112, etc.) for carrying out the operations described herein, in accordance with one or more aspects of the present disclosure. Instructions 425 may also reside, completely or at least partially, within main memory 404 and/or within processing device 402 during execution thereof by computing device 400, main memory 404 and processing device 402 also constituting computer-readable media. The instructions 425 may further be transmitted or received over a communication network 420 via network interface device 408.

While computer-readable storage medium 428 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving,” “searching,” “generating,” “determining,” “updating,” “performing,” “identifying,” “adding,” “determine,” “rebalancing,” “abstaining,” “partitioning,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware-- for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112(f), for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present embodiments to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present embodiments are not to be limited to the details given herein, but may be modified within the scope and equivalents of the appended claims.

1. A method comprising:
receiving a request to identify, in a database system, a collection of log events respectively associated with a collection of log files according to a selection criteria and an event type;
analyzing, by a query compiler, the request to generate a compiled query indicating a hierarchical structure of a plurality of commands included in the request;
determining, by a command type detector of a runtime environment, that the request is a request to search the database system;
searching the database system to identify a set of log events based on the event type, wherein searching the database system comprises retrieving, by a logline fetcher of the runtime environment, each log mapping from the database system and forwarding the retrieved log mappings to a database searching service to be sequentially processed to generate a plurality of groups for the set of log events;
generating, by a processing device, the plurality of groups for the set of log events by assigning a first log event of the set of log events to a first group based on additional log events within the first group and assigning a second log event of the set of log events to the first group based on the additional log events in the first group; and
generating, from the plurality of groups, a report indicating that a subset of the set of log events correspond to the selection criteria.

2. The method of claim 1, wherein the selection criteria comprises a first rule to select, from the plurality of groups, smallest log events corresponding to the event type, and a second rule to select a total count of the smallest log events from the plurality of groups, and further comprising:
sending the report to a client device to be used by the client device to determine an additional selection criteria and an additional event type based on the report, and send a second request to the processing device, wherein the second request is to identify, in the database system, an additional collection of log events according to the additional selection criteria and the additional event type.

3. The method of claim 1, wherein generating the plurality of groups further comprises:
determining a first minimum log event and a first maximum log event from a first set of assigned log events in the first group;
determining a second minimum log event and a second maximum log event from a second set of assigned log events in a second group; and
updating a plurality of pointers to indicate at least one of the first minimum log event, the first maximum log event, the second minimum log event, or the second maximum log event.

4. The method of claim 3, wherein generating the plurality of groups further comprises:
performing, based on the plurality of pointers, a binary search to determine that a third log event of the set of log events is less than the first minimum log event in the first group and the second minimum log event in the second group;
identifying the first group as a nearest neighboring group for the third log event responsive to performing the binary search; and
adding the third log event to the first group responsive to identifying the first group as the nearest neighboring group for the third log event; or
performing, based on the plurality of pointers, a binary search to determine that a third log event of the set of log events is greater than the first maximum log event in the first group and less than the second minimum log event in the second group;
identifying the first group and the second group as nearest neighboring groups for the third log event; and
determining that the second group is smaller than the first group based on a first total count of log events in the first group and a second total count of log events in the second group.

5. The method of claim 4, further comprising:
remediate a cybersecurity threat based on the third log event.

6. The method of claim 4, wherein generating the plurality of groups further comprises:
determine whether the second total count of log events in the second group exceeds a hysteresis value; and either:
adding the third log event to the second group responsive to determining that the second total count of log events in the second group does not exceed the hysteresis value, or
adding, to the plurality of groups, an additional group comprising the third log event responsive to determining that the second total count of log events in the second group exceeds the hysteresis value.

7. The method of claim 4, wherein generating the plurality of groups further comprises:
determining an inability to add the third log event to one or more groups of the plurality of groups; and
rebalancing the plurality of groups based on the third log event.

8. The method of claim 3, wherein generating the plurality of groups further comprises:
performing, based on the plurality of pointers, a binary search to determine that a third log event of the set of log events falls within the first group based on the first minimum log event in the first group and the first minimum log event in the first group;
determining whether there is space to add the third log event to the first group; and either:
adding the third log event to the first group responsive to determining that there is space to add the third log event to the first group, or
abstaining from adding the third log event to the first group responsive to determining that there is no space to add the third log event to the first group.

9. The method of claim 8, wherein abstaining from adding the third log event to the first group further comprises:
determining whether there is space to add an additional group to the plurality of groups; and either:
partitioning, based on the third log event, the additional group into a third group and a fourth group responsive to determining that there is space to add the additional group to the plurality of groups; or
rebalancing the plurality of groups based on the third log event responsive to determining that there is no space to add the additional group to the plurality of groups.

10. The method of claim 9, wherein partitioning, based on the third log event, the additional group into the third group and the second group further comprises:
determining that the third group is smaller than the fourth group based on a third total count of log events in the third group and a fourth total count of log events in the fourth group; and
adding the third log event to the third group responsive to determining that the third group is smaller than the fourth group.

11. A system comprising:
a memory; and
a processing device, operatively coupled to the memory, to:
receive a request to identify, in a database system, a collection of log events respectively associated with a collection of log files according to a selection criteria and an event type;
analyze, by a query compiler, the request to generate a compiled query indicating a hierarchical structure of a plurality of commands included in the request;
determine, by a command type detector of a runtime environment, that the request is a request to search the database system;
search the database system to identify a set of log events based on the event type, wherein searching the database system comprises retrieving, by a logline fetcher of the runtime environment, each log mapping from the database system and forwarding the retrieved log mappings to a database searching service to be sequentially processed to generate a plurality of groups for the set of log events;
generate the plurality of groups for the set of log events by assigning a first log event of the set of log events to a first group based on additional log events within the first group and assigning a second log event of the set of log events to the first group based on the additional log events in the first group; and
generate, from the plurality of groups, a report indicating that a subset of the set of log events correspond to the selection criteria.

12. The system of claim 11, wherein the selection criteria comprises a first rule to select, from the plurality of groups, smallest log events corresponding to the event type, and a second rule to select a total count of the smallest log events from the plurality of groups, and wherein the processing device is further to:
send the report to a client device to be used by the client device to determine an additional selection criteria and an additional event type based on the report, and send a second request to the processing device, wherein the second request is to identify, in the database system, an additional collection of log events according to the additional selection criteria and the additional event type.

13. The system of claim 11, wherein to generate the plurality of groups, the processing device is further to:
determine a first minimum log event and a first maximum log event from a first set of assigned log events in the first group;
determine a second minimum log event and a second maximum log event from a second set of assigned log events in a second group; and
update a plurality of pointers to indicate at least one of the first minimum log event, the first maximum log event, the second minimum log event, or the second maximum log event.

14. The system of claim 13, wherein to generate the plurality of groups, the processing device is further to:
perform, based on the plurality of pointers, a binary search to determine that a third log event of the set of log events is less than the first minimum log event in the first group and the second minimum log event in the second group;
identify the first group as a nearest neighboring group for the third log event responsive to performing the binary search; and
add the third log event to the first group responsive to identifying the first group as the nearest neighboring group for the third log event; or
perform, based on the plurality of pointers, a binary search to determine that a third log event of the set of log events is greater than the first maximum log event in the first group and less than the second minimum log event in the second group;
identify the first group and the second group as nearest neighboring groups for the third log event; and
determine that the second group is smaller than the first group based on a first total count of log events in the first group and a second total count of log events in the second group.

15. The system of claim 14, wherein to generate the plurality of groups, the processing device is further to:
remediate a cybersecurity threat based on the third log event.

16. The system of claim 14, wherein to generate the plurality of groups, the processing device is further to:
determine whether the second total count of log events in the second group exceeds a hysteresis value; and either,
add the third log event to the second group responsive to determining that the second total count of log events in the second group does not exceed the hysteresis value; or
add, to the plurality of groups, an additional group comprising the third log event responsive to determining that the second total count of log events in the second group exceeds the hysteresis value.

17. The system of claim 14, wherein to generate the plurality of groups, the processing device is further to:
determine an inability to add the third log event to one or more groups of the plurality of groups; and
rebalance the plurality of groups based on the third log event.

18. The system of claim 13, wherein to generate the plurality of groups, the processing device is further to:
perform, based on the plurality of pointers, a binary search to determine that a third log event of the set of log events falls within the first group based on the first minimum log event in the first group and the first minimum log event in the first group;
determine whether there is space to add the third log event to the first group; and either,
add the third log event to the first group responsive to determining that there is space to add the third log event to the first group; or
abstain from adding the third log event to the first group responsive to determining that there is no space to add the third log event to the first group.

19. The system of claim 18, wherein to abstain from adding the third log event to the first group, the processing device is further to:
determine whether there is space to add an additional group to the plurality of groups;
partition, based on the third log event, the additional group into a third group and a fourth group responsive to determining that there is space to add the additional group to the plurality of groups; and
rebalance the plurality of groups based on the third log event responsive to determining that there is no space to add the additional group to the plurality of groups.

20. A non-transitory computer-readable medium storing instructions that, when executed by a processing device, cause the processing device to:
receive a request to identify, in a database system, a collection of log events respectively associated with a collection of log files according to a selection criteria and an event type;
analyze, by a query compiler, the request to generate a compiled query indicating a hierarchical structure of a plurality of commands included in the request;
determine, by a command type detector of a runtime environment, that the request is a request to search the database system;
search the database system to identify a set of log events based on the event type, wherein searching the database system comprises retrieving, by a logline fetcher of the runtime environment, each log mapping from the database system and forwarding the retrieved log mappings to a database searching service to be sequentially processed to generate a plurality of groups for the set of log events;
generate, by the processing device, the plurality of groups for the set of log events by assigning a first log event of the set of log events to a first group based on additional log events within the first group and assigning a second log event of the set of log events to the first group based on the additional log events in the first group; and
generate, from the plurality of groups, a report indicating that a subset of the set of log events correspond to the selection criteria.
